(19) United States
(12) Patent Application Publication
(10) Pub. No.: US 2026/0031433 A1
(43) Pub. Date: Jan. 29, 2026

(54) ELECTRONIC POWER UNITS AND RELATED METHODS

(71) Applicant: Aviation Battery Systems LLC, Fountain Hills, AZ (US)

(72) Inventor: Todd Petersen, Fountain Hills, AZ (US)

(21) Appl. No.: 19/186,613

(22) Filed: Apr. 22, 2025

Related U.S. Application Data
(60) Provisional application No. 63/637,265, filed on Apr. 22, 2024.

(51) Int. Cl. H01M 10/657; B60R 16/023; B60R 16/033; F02D 41/06; H01M 10/42; H01M 10/44; H01M 10/48; H01M 10/615; H01M 10/625; H02J 7/00

(52) U.S. Cl. CPC H01M 10/657; B60R 16/0231; B60R 16/033; F02D 41/062; H01M 10/425; H01M 10/44; H01M 10/482; H01M 10/486; H01M 10/615; H01M 10/625; H02J 7/0013; H02J 7/0047; H02J 7/007194; H01M 2220/20

(57) ABSTRACT

Implementations of an electronic power unit may include a heater disposed in a battery pack, the heater electrically coupled with a heater controller and with a battery controller; and an exterior case, the exterior case enclosing the heater and the battery pack, the exterior case including an end that accommodates the power input of a military vehicle, the end including a coaxial connector.

### CROSS REFERENCE TO RELATED APPLICATIONS

This document claims the benefit of the filing date of U.S. Provisional Patent Application 63/637,265, entitled “Electronic Power Units and Related Methods” to Todd Petersen which was filed on Apr. 22, 2024, the disclosure of which is hereby incorporated entirely herein by reference.

### BACKGROUND

### 1. Technical Field

Aspects of this document relate generally to battery systems. More specific implementations involve battery systems used to start various vehicles.

### 2. Background

Various vehicles utilize different types of engines to provide propulsion. Some engines utilize various type of fossil fuels as an energy source such as internal combustion engines or steam engines. Other types of engines work to provide different forms of mechanical energy such as rotational energy or water flow energy.

### SUMMARY

Implementations of a heating system for an electronic power unit may include a plate including one or more heating elements, the plate including a thickness; a metal oxide field effect transistor electrically coupled with the one or more heating elements of the plate; and a heater controller electrically coupled with the metal oxide field effect transistor and with the one or more heating elements. The thickness of the plate may be dimensioned to allow the plate to be inserted between a first set of battery cells and a second set of battery cells of an electronic power unit. The perimeter of the plate may be dimensioned to fit entirely within an enclosure of an electronic power unit.

Implementations of a heating system for an electronic power unit may include one, all, or any of the following:

The one or more heating elements may be on a surface of the plate.

The one or more heating elements may be in the plate.

The one or more heating elements may be in a material of the plate.

The heating system may include a heat sink thermally coupled with the plate.

The perimeter of a largest planar surface of the heat sink may be substantially coextensive with the perimeter of the plate.

The heating system may include a battery controller including a microcontroller and memory including machine readable instructions that, when executed by the microcontroller may be configured to: use a temperature sensor operatively coupled to the battery controller, detect a temperature of first set of battery cells and the second set of battery cells; if no charger may be connected to the electronic power unit: send a signal to the heater controller instructing the heater controller to activate the heater; and when the temperature sensor detects that the temperature of the first set of battery cells and second set of battery cells may have reached a predetermined temperature, send a signal to the heater controller to deactivate the heater; and if the battery controller detects that a future state of charge of the first set of battery cells and second set of battery cells at the current temperature may be below a predetermined level, the battery controller sends a signal to the heater controller instructing the heater to deactivate.

The heating system may include a battery controller including a microcontroller and memory including machine readable instructions that, when executed by the microcontroller may be configured to: use a temperature sensor operatively coupled to the battery controller, detect a temperature of first set of battery cells and the second set of battery cells; if a charger may be connected to the electronic power unit: using the battery controller, detect a state of charge of the first set of battery cells and second set of battery cells and one of: if the state of charge may be below a predetermined level and the temperature may be below a predetermined temperature: with the battery controller, charge the first set of battery cells and second set of battery cells until the state of charge reaches the predetermined level; reduce the charging rate; and send a signal to the heater controller to activate the heater to heat the first set of battery cells and second set of battery cells until the temperature reaches the predetermined temperature; or if the state of charge may be below a predetermined level and the temperature of the battery may be below a predetermined temperature: with the battery controller, charge the first set of battery cells and second set of battery cells until the state of charge reaches the predetermined level; and send a signal to the heater controller to activate the heater to heat the first set of battery cells and second set of battery cells during the charging until the temperature reaches the predetermined temperature.

The heating system may include a battery controller including a microcontroller and memory including machine readable instructions that, when executed by the microcontroller may be configured to: use a temperature sensor operatively coupled to the battery controller, detect a temperature of the first set of battery cells and the second set of battery cells; using the battery controller, detect a state of charge of the first set of battery cells and second set of battery cells; if the starting state of charge may be at a desired level, with the battery controller, send a signal to the heater controller to maintain the first set of battery cells and second set of battery cells at a desired temperature; if the battery controller enters a shutdown state, use the heater controller to continue to monitor the temperature and if the temperature drops below the desired temperature, activating the heater to heat the first set of battery cells and the second set of battery cells to a desired temperature.

The heater controller may be configured to: detect when the electronic power unit may be in use and one of not beginning heating or ceasing heating; track a state of charge of the first set of battery cells and second set of battery cells and deactivating the one or more heating elements when the state of charge falls below a predetermined level; detect a fault condition in the first set of battery cells and second set of battery cells and not beginning heating or ceasing heating; or any combination thereof.

Implementations of a method of recharging an electronic power unit may include using an electronic power unit, starting an engine of a vehicle; maintaining the electronic power unit in electrical connection with the vehicle after starting the engine; and receiving electrical charge from the vehicle into the electronic power unit to charge the electronic power unit.

Implementations of a method of recharging an electronic power supply may include one, all, or any of the following:

The electrical charge fully recharges the electronic power unit.

The electrical charge partially recharges the electronic power unit.

The electrical charge replaces electrical charge discharged from the electronic power unit while starting the engine of the vehicle.

Receiving electrical charge from the vehicle into the electronic power unit further may include receiving at an end of the electronic power unit used to start the engine of the vehicle.

Implementations of an electronic power unit may include a heater disposed in a battery pack, the heater electrically coupled with a heater controller and with a battery controller; and an exterior case, the exterior case enclosing the heater and the battery pack, the exterior case including an end that accommodates the power input of a military vehicle, the end including a coaxial connector.

Implementations of an electronic power unit may include one, all, or any of the following:

The coaxial connector may be a North American Treaty Organization connector (NATO Slave Connector or NATO Slave Receptacle).

An outer surface of the end may be substantially cylindrical and the end may include a single substantially cylindrical opening therein.

The coaxial connector contains a non-metallic, electrically conductive, field serviceable tip that prevents transfer of metal or welding of the coaxial connector when it may be attached directly to an active load that would cause material transfer or arching upon contact.

The method where the field-serviceable tip may be coupled using a screw.

The foregoing and other aspects, features, and advantages will be apparent to those artisans of ordinary skill in the art from the DESCRIPTION and DRAWINGS, and from the CLAIMS.

### BRIEF DESCRIPTION OF THE DRAWINGS

Implementations will hereinafter be described in conjunction with the appended drawings, where like designations denote like elements, and;

FIG. 1 is a perspective view of an implementation of an electronic power unit;

FIG. 2 is another perspective view of the electronic power unit of FIG. 1;

FIG. 3 is a perspective view of another implementation of an electronic power unit for use with military vehicles;

FIG. 4 is a perspective view of the electronic power unit of FIG. 3 with an external cover and other components removed;

FIG. 5 is a perspective view of another implementation of an electronic power unit;

FIG. 6 is another perspective view of the electronic power unit implementation of FIG. 5;

FIG. 7 is a perspective view of another implementation of an electronic power unit with a cover and part of a battery pack removed;

FIG. 8 is a perspective view of an implementation of an electronic power unit with an implementation of a battery heater installed therein;

FIG. 9 is a circuit diagram of an implementation of a battery charging circuit;

FIG. 10 is a graph of a switching time of a battery charging circuit implementation;

FIG. 11 is a graph of an engine start profile of an aircraft turbine engine;

FIG. 12 is a flow diagram of an implementation of a method of detecting an engine start when an electronic power unit is in use;

FIG. 13 is a flow diagram of an implementation of a method of data collection for a battery used in an electronic power unit; and

FIG. 14 is a block diagram of an implementation of an electronic power unit battery monitoring system that includes a microcontroller and a memory; and

FIG. 15 is an exploded view of an implementation of a electrically conductive, non-metallic device.

### DESCRIPTION

This disclosure, its aspects and implementations, are not limited to the specific components, assembly procedures or method elements disclosed herein. Many additional components, assembly procedures and/or method elements known in the art consistent with the intended electronic power units and related methods will become apparent for use with particular implementations from this disclosure. Accordingly, for example, although particular implementations are disclosed, such implementations and implementing components may comprise any shape, size, style, type, model, version, measurement, concentration, material, quantity, method element, step, and/or the like as is known in the art for such electronic power units, and implementing components and methods, consistent with the intended operation and methods.

U.S. Pat. App. Pub. No. 20140210399 ('399 Publication) to Urschel et al. entitled “Portable Electric Power Source for Aircraft,” application Ser. No. 13/750,295, filed Jan. 25, 2013, the disclosure of which is hereby incorporated entirely herein by reference, discloses various implementations of portable power sources for aircraft and outlines various methods and charging structures. Various challenges associated with portable power sources like those disclosed in the '399 Publication include avoiding excessive heat generation/damage of electrical components during use, ensuring the battery in the unit are warm enough at the time of use, and assessing at what point a battery is at along a lifespan of the battery.

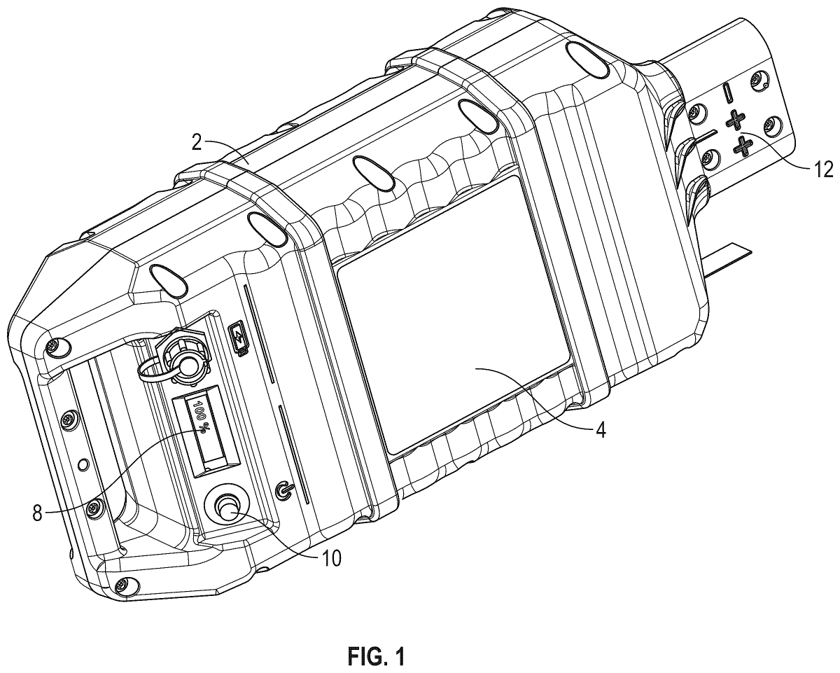

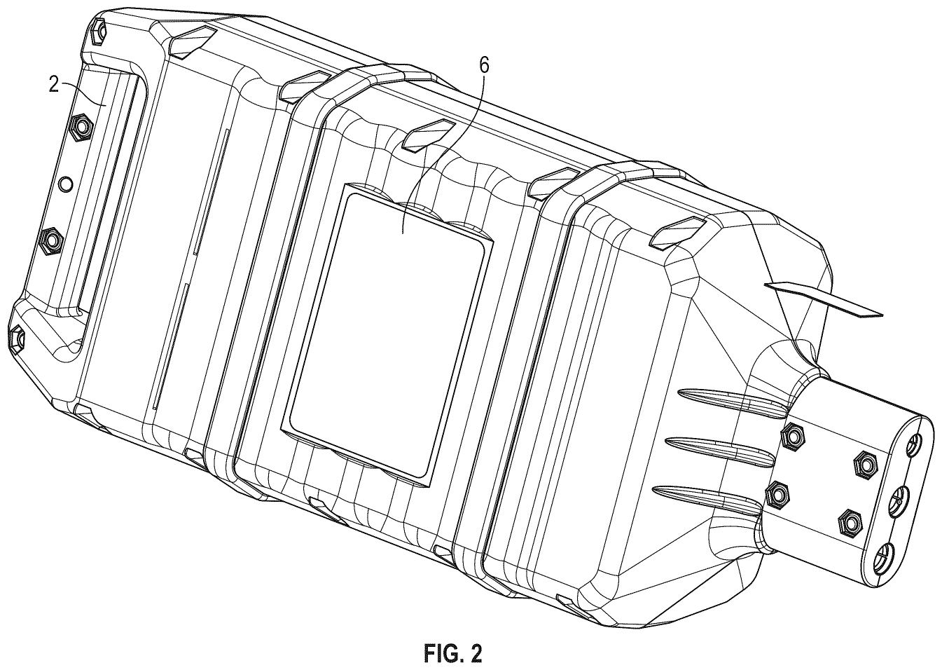

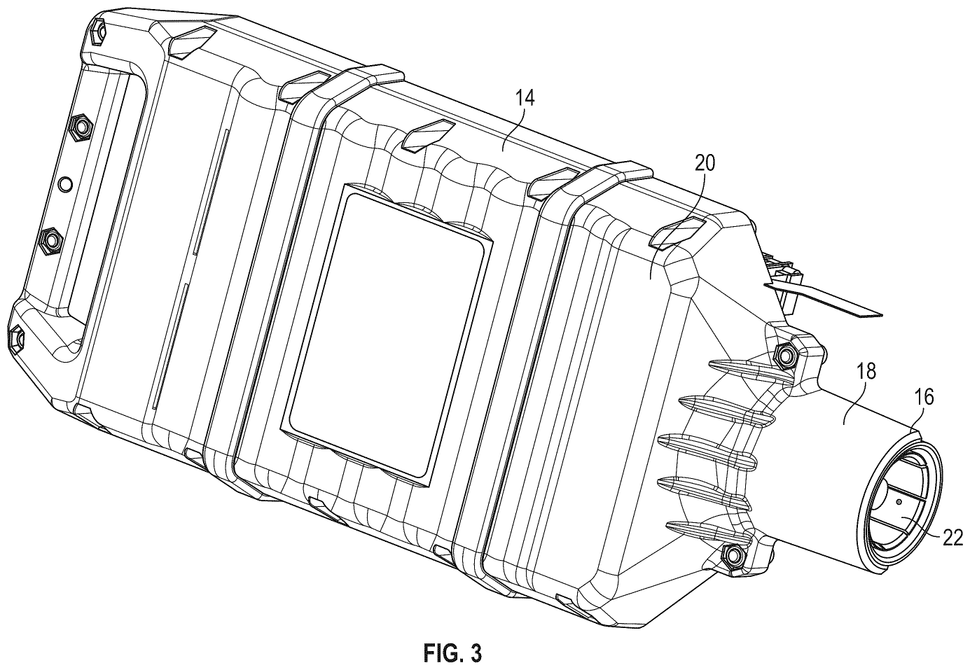

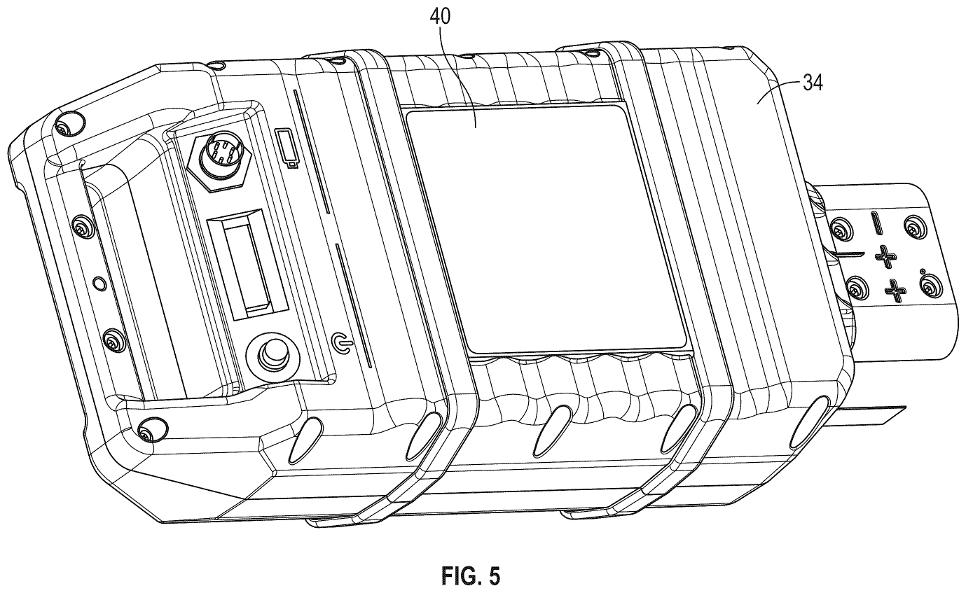

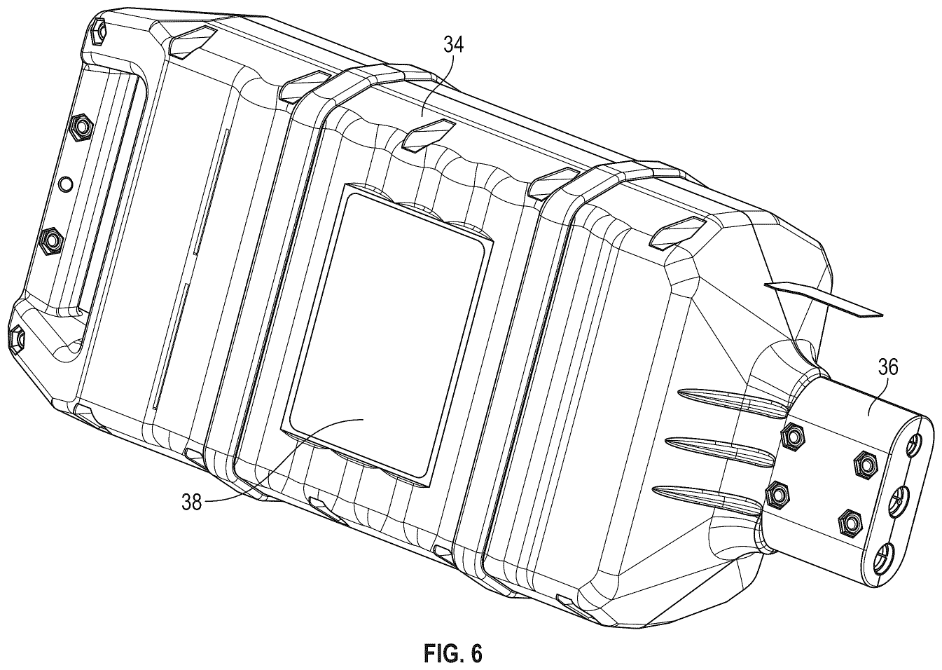

Referring to FIGS. 1 and 2, an implementation of an electronic power unit 2 is illustrated in two perspective views. As illustrated in this implementation, locations 4, 6 for screens/displays, which may be liquid crystal displays (LCDs) or organic light emitting diode (OLED) displays appear in the grayed regions. The units also contain an additional display 8 located near a power button 10. The electronic power unit implementation illustrated in FIGS. 1 and 2 is configured for use for civilian aircraft as the end 12 of the electronic power unit 2 is designed to accommodate the power input for various aircraft engines. Referring to FIGS. 5 and 6, an implementation of an electronic power unit 14 for use in military aircraft is illustrated which contains end 16, but whose components are designed to handle military operating conditions. As illustrated in FIG. 3, the end 16 includes a substantially cylindrical outer surface 18. By inspection it can be observed that while the outer surface is slightly tapered from the point where the surface meets the exterior case 20, it is substantially cylindrical along the length of the outer surface as it extends from the exterior case 20 to the tip of the end 16. Also, by inspection, the end 16 includes a single substantially cylindrical opening 22 in the end 16. While the single cylindrical opening 22 can also be described as being a polygonal opening through observation of FIG. 3, the lengths of the sides of the polygon are sufficiently short to where the opening can be described as substantially cylindrical.

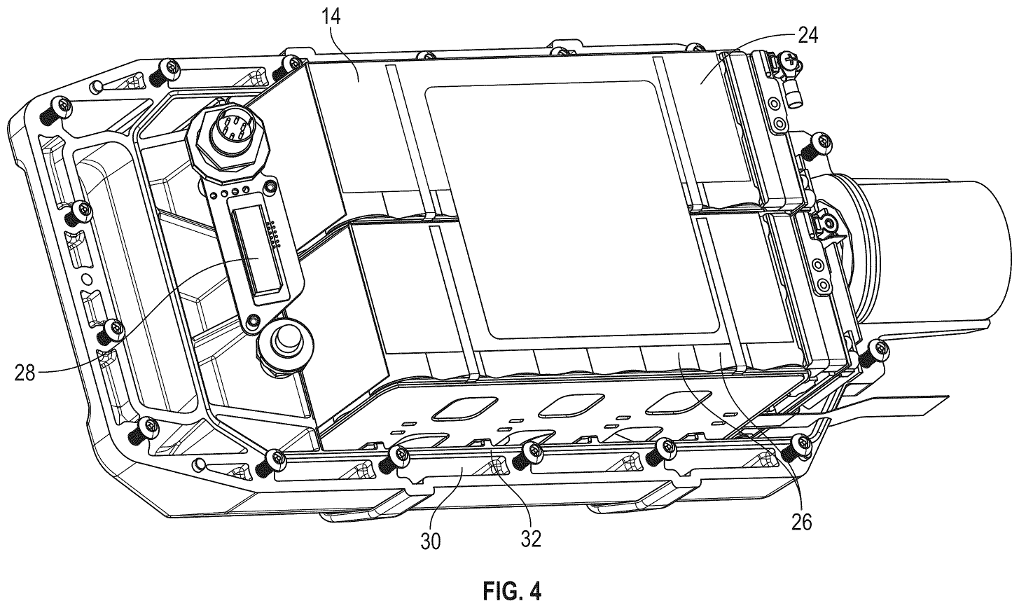

The electronic power unit implementation of FIGS. 3-4 is used for various military vehicles including land vehicles. The shape of the end that delivers electric power in this implementation takes the form of a North American Treaty Organization standard (NATO) connector, also referred to as a NATO Slave Cable Connector or NATO Slave Receptacle which is used in a wide variety of western military equipment. The NATO connector can also be described as being a coaxial connector. While the use of a NATO connector is illustrated in this implementation, other connector designs could be employed as well used in other military vehicles. Also, while the use of a military type connector is illustrated in this implementation, in other implementations, a civilian version of the electronic power unit could be constructed that includes various connectors used in various civilian vehicles including, by non-limiting example, land vehicles, gas and diesel generators, water vehicles, or other civilian aircraft.

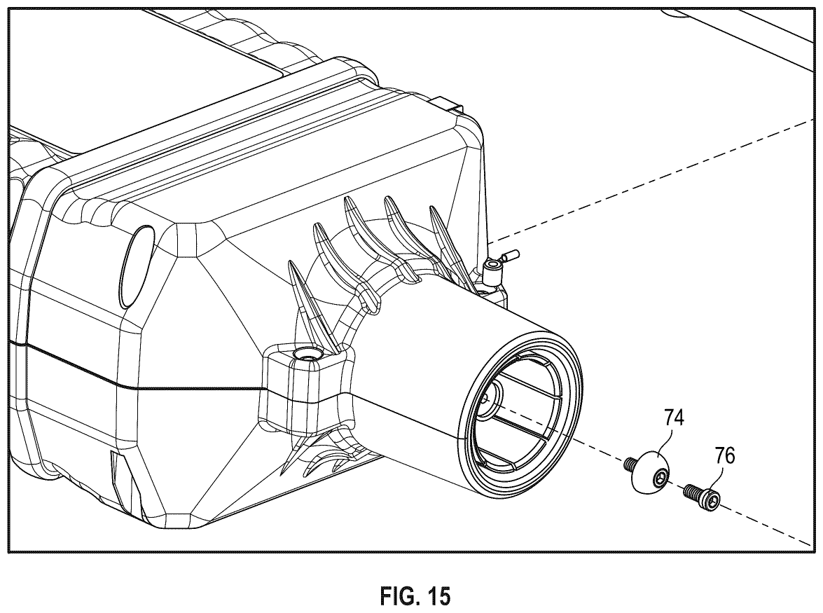

When transmitting large currents between devices, the point of first contact between the supply and the load can cause electrical arcing. The larger the voltage and lower the impedance differences between these devices, the more arcing can occur. Arcing can cause material transfer at the point where the circuit is made or broken. In the worst case, enough material transfer can lead to welding of the devices to one another. To prevent this, the electric power unit implementations can contain an electrically conductive, non-metallic device located at the first point of contact between electrical conductors that prevents welding and arcing. In one implementation, this device can be made of stranded carbon fiber facilitating in-field replacement using a single fastener and common tools, avoiding the need to send the unit in for service. FIG. 15 shows an illustration of this anti-arcing device 74 which takes the form of an exchangeable tip that can be changed out using a screw 76 and hand tools. Note that in FIG. 15, the exchangeable tip 74 is illustrated with the screw 76 separated from the tip 74 in an exploded view and also with the screw 76 inserted into an opening in the end of the tip 74 in preparation for being screwed into the end of the coaxial connector. Thus only one screw 76 is actually used to fasten the exchangeable tip to the coaxial connector. The shape of the tip takes the form of a half sphere.

When the electric power unit is connected to a load, it consumes energy from the electric power unit that needs to be replenished in order to provide ongoing utility to the user. In some cases, these electrical loads can turn into electrical supplies whereby they can back-feed energy into the electric power unit. This is the case when connecting to a fossil fueled engine with an alternator, which can provide after the engine has been started, in various cases, hundreds of amperes of electrical power. In these cases, the electric power unit will use this supply to charge the battery such that that electric power unit can be used for an extended period of time.

When accepting power from a high-current supply, it is critically important that the batteries are maintained in a safe manner, managing temperatures, voltages, and electrical currents as to prevent any permanent damage to the physical or chemical structures. The electric power unit manages these aspects in a charge recovery mode.

The charge recovery mode in the electric power unit includes a current limiting device such as an array of metal oxide field effect transistors (MOSFET) connected to a controller capable of pulse width modulation (PWM) at a set or variable frequency to limit current by limiting the duty cycle of the PWM. This method prevents any current carrying electrical, mechanical, or chemical structures from being damaged from over-current.

The electric power unit also monitors temperatures near and within critical electrical components and battery temperature using in a non-limited example a temperature sensor such as a thermistor or thermocouple. The electric power unit also monitors the internal temperature of the battery cells using a software model that translates surface temperatures of the cells into a core temperature of any battery cell. These temperatures are monitored by a microcontroller and when they exceed a threshold, current is limited from the source device in recovery mode.

The electric power unit considers upper and lower voltage limits at various places within the device. The microcontroller avoids voltages caused by charging of the battery that damages the battery by causing excessive heating or damage to chemical structures. Lower limits are also monitored. In a non-limiting example, if voltages within the electric power unit are too low prior to charging via the recovery mode, the recovery mode may be disabled (turned off) to avoid damage to chemistry or components.

FIG. 4 is a view with the outer cover removed that shows the interior structure of the electronic power unit including the battery 24 (battery pack) that is illustrated as being composed of a plurality of battery cells 26 that are wired together in series, parallel, or any combination of series and parallel to achieve the desired output voltage and current from the battery 24. Also illustrated is display 28, which currently is displaying the total charge (100%) of the battery. One of the challenges of working with a battery of this size in a confined space like the case of the electronic power unit is that the exterior case 30 may be sealed using an o-ring 32 or other sealing system to prevent entry of water into the electronic power unit 14 during use. This waterproof sealing prevents the use of passive or active cooling devices to cool the battery and also prevents heating or warming of the battery using an external system because the material of the case (generally a polymer or other plastic) does not conduct heat as well as the metallic components of the electronic power unit.

Because of the relatively large thermal mass of the battery, in cold conditions, it will take the battery a considerably long time to be warmed after the case is placed in a warming enclosure. Because of this, the use of external warming systems for a portable device like this are bulky and may not be available in locations where the portable power unit is used. Furthermore, the portable power unit needs to be designed to operate in temperatures below −45 C to meet military operational requirements. This low temperature is significantly challenging for any battery chemistry involving ion transfer as battery chemistries generally experience degraded performance at lower temperatures due to lower ion mobility. For example, the battery in the electronic power unit implementation illustrated in the '399 Publication begins to experience electrical performance degradation around 15 C.

Referring to FIGS. 5 and 6, another implementation of an electronic power unit 34 is illustrated which is also adapted for use in military applications but which includes an end 36 like the implementation of FIGS. 1-2 that has an ellipsoidal shape. The electronic power unit 34 also includes displays 38, 40 similar to those previously discussed.

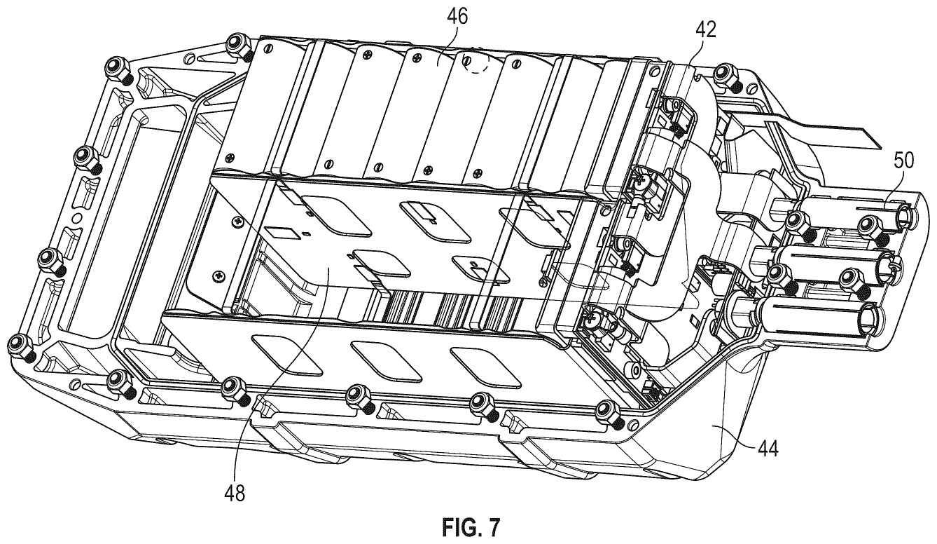

Referring to FIG. 7, an implementation of an electronic power unit 42 like that illustrated in FIGS. 1-2 is illustrated with a portion of the exterior case 44 removed and with half of the battery cells and other surrounding equipment removed to allow for exposure of the internal structure of the battery (battery pack) between the two sets of cells 46. Here a structure has been selected that is highlighted and takes the form of a heat sink 48 designed to remove heat from the cells of the battery during an operational discharge, which creates heat in each of the cells. This heat is then transferred to the other metallic components of the electronic power unit for dispersion including into the receivers 50 that connect with the conductors of the engine or cable attached to the engine to which the electronic power unit is coupled.

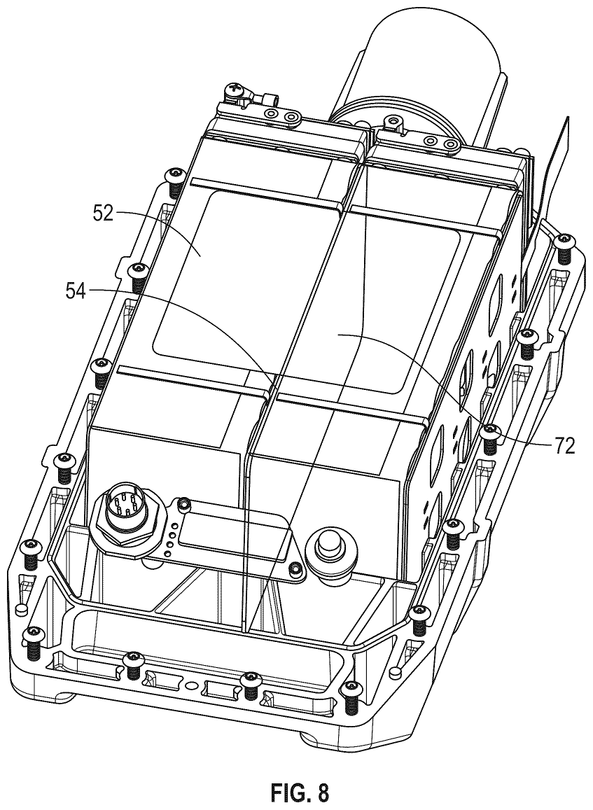

Referring to FIG. 8, another implementation of an electronic power unit 52 is illustrated that shows how a heater 54 is located adjacent to or in place of the heat sink 48 of the electronic power unit 42 of FIG. 7 between the sets of battery cells. For those implementations where the heater 54 is located adjacent to the heat sink 48, the heat from the heater 12 uses the heat sink 10 to assist with transferring heat to each cell (set of cells) uniformly to aid in maintaining as uniform temperature profile within the battery as possible. For those implementations where the heater 54 is used in place of the heat sink 48, the heater 54 can function as a passive heat sink when not electrically activated due to being similar in size and location as the heat sink 48.

In various system implementations, the heater 54 is connected to a dedicated metal oxide field effect transistor (MOSFET) that is connected to a heater controller (not shown in FIG. 8, but included in electronics included in the case. Various system implementations may utilize one or more methods/modes of operating the heater 54 using the heater controller, drawing power for the heater from the battery. In various method implementations, the method utilized may depend on whether there is a battery charger/power supply connected to the electronic power unit itself.

In particular method implementations, when no charger is attached and the battery has woken up (or the battery controller has woken up and is assessing the condition of the battery), if the temperature of the battery is below a predetermined point, the battery/system controller will prompt the user via the screen whether the heater should be turned on. Waiting for a prompt to begin heating the battery can matter because if the battery heats quite quickly relative to a storage time of the battery between uses, some considerable energy keeping the battery warm may be wasted. In response to the prompt from the user to turn on the battery, the heater controller then supplies power to the heater using a predetermined routine/control program to warm the battery to a desired set point temperature. When the battery reaches the desired set point temperature, the heater controller may turn off the heater entirely or after a predetermined period of time has passed after the set point temperature has been reached. In various method implementations, if the battery controller detects the state of charge (SOC) of the battery has reached a level where, below this point, the electronic power unit may be unable to supply power for a single engine start, the battery controller sends a signal to the heater controller for the heater controller to turn off the heater at that time, regardless of the battery temperature. In various method implementations, the detection of the SOC may take into account the SOC at the current temperature of the battery and the SOC at the previous/ambient temperature when making the calculation when to send the turn off signal to the heater controller.

In a particular method implementation, when a charger/power supply is coupled to the electronic power unit, where the SOC is detected by the battery controller to be below a predetermined level and the temperature of the battery is below a set point temperature, the battery controller will prioritize charging of the battery first until the SOC has passed the predetermined level. At that point, the battery controller then may reduce the charging rate and then send a signal to the heater controller to activate the heater until the temperature batter reaches the set point. This method implementation may ensure that the battery is ready with a level of charge capable of performing multiple engine starts and the temperature of the battery is optimized to participate in those engine starts.

In other method implementations, if the temperature of the battery is below a predetermined low temperature set point, the battery controller may activate both the heater using the heater controller while charging the battery to aid in increasing the rate at which the battery can be charged because the charging process may not generate sufficient heat on its own to prevent an overly low charging rate to be maintained. In various method implementations, when the SOC reaches a full level or other desired level, the heater controller may maintain the battery temperature using the heater indefinitely while the battery is in an on state controlled by the battery controller. Where the battery controller employs a method of automatically shutting down to save battery life, while the battery controller is in shutdown state from the automatic shut down function, the battery controller may continue to monitor the battery temperature. If the battery temperature falls below a certain set point and if the SOC is full or above a certain level, the battery controller/heater controller may then continue to maintain heating or turn on the heater to begin heating again.

In various method implementations, the heater controller monitors the heating rate (dT/dt) and displays a calculated time when the battery will have reached the set point temperature. In various implementations, the heater controller has the ability to shunt power between the heater and the charging circuitry of the battery controller to ensure that the current/power capacity of the charger/power supply attached is not exceeded. Various implementations of heater controllers may heat the battery based on the battery core temperature using a thermocouple or other temperature sensor located in the interior of the battery. In various method implementations, the heater controller may be user activatable/deactivatable via options available through the display. The heater controller may also track SOC of the battery independent of the battery controller and then deactivate the heater at a predetermined low value of SOC (25% in some implementations). The heater controller may also be aware of/detect various battery fault conditions, such as, by non-limiting example, over-temperature, over-voltage, or any other fault condition where eliminating heating may be desirable/important. The heater controller may also be designed to detect when the electronic power unit is in use and not begin heating during use or cease heating during use.

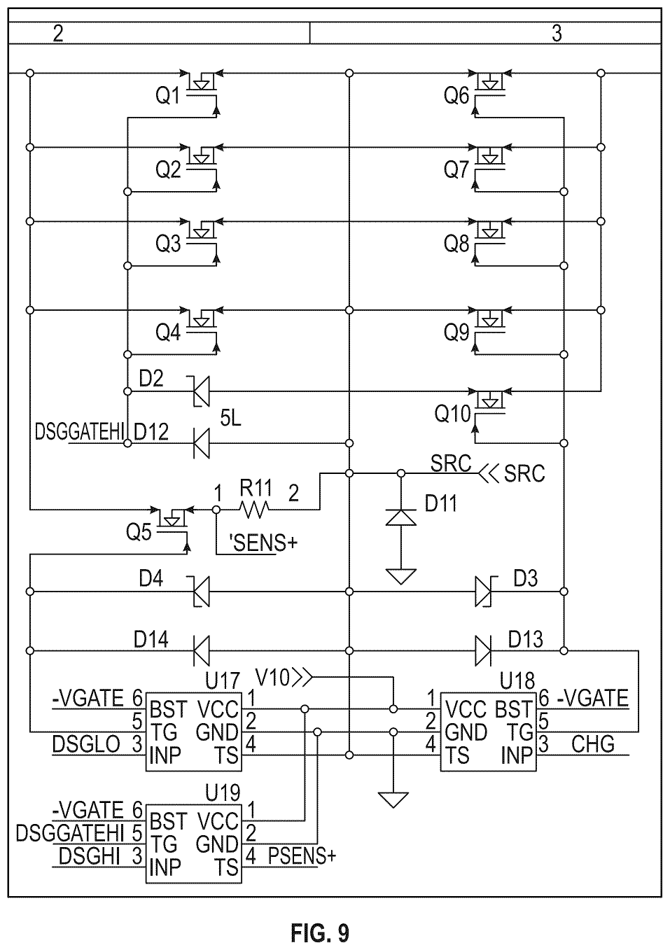

Referring to FIG. 9, a schematic of a circuit that includes multiple FETs arranged for charging the battery is illustrated. This circuit is designed to be operated in a two or multi-step mode during discharge as part of/in combination with the battery controller. The use of a high speed two or multi-step mode is a feature that allows the electronic power unit to optimize both range and resolution of the current sensor within the power electronics design, while also optimizing heat generation. The implementation in the electronic power unit involves two arrays of MOSFETs positioned in parallel, which, in a particular implementation, results in 79% less heat generation and 12× improvement in current resolution below 50 A.

As illustrated in FIG. 9, the circuit includes a plurality of MOSFET arrays. All arrays involve a MOSFET or plurality of MOSFETS oriented in parallel to form a current divider circuit. A current sensor is positioned in series with one or more of the MOSFETS within one or more of the legs of one or more of the arrays. Multiple arrays are then oriented as a group to form a larger current divider where each array can be controlled independently or together with one or more of the other arrays such that current flowing from the battery to the load communicates with all of the arrays. Arrays are switched on or off using the battery controller to achieve a desired range and resolution of the resultant current divider constructed of the plurality of arrays. This ability to involve multiple arrays of MOSFETS allows the battery controller to have multiple modes of operation. By non-limiting example, one mode may be a “Hi” range which can be achieved by turning on one or both of the arrays while another mode can be a “Low” range which can be achieved by turning a different combination of arrays. In some implementations, an additional range(s) may be employed which could be a “Mid” or other desired range.

In one implementation, at low current flows, the battery controller turns on one or more of the arrays that produces a high resolution. This is especially important for constant current/constant voltage battery charging algorithms and for tracking State of Charge (SOC) at low currents. Similarly, at high current flows, an implementation of the battery controller chooses a different mode that includes a different combination of MOSFET arrays that produce a high current sensing range which important for measuring over-currents and short-circuit conditions without saturating the sensor signal.

In various method implementations employed by the battery controller, it is important to switch the arrays on and off quickly so as to not over-current any one of the MOSFETS or have undesirable resolution, range, or heat generation. One example of such a method implementation is with an interrupt service routine (ISR) within an micro controller unit (MCU) included in the battery controller which is coupled to either internal or external comparators that trigger based on preset current levels. In such implementations, the MCU monitors the current and quickly turns on or off the arrays according to desired range/resolution for each mode. For short circuits while in a lower current mode, the array is designed to accommodate excess current for the time it takes to get another array turned on or to turn off all arrays if a battery controller intervention is required.

The various circuit designs may be used by the electronic power unit to optimize the range and resolution of the current sensor, but also to optimize thermal efficiency by turning on enough MOSFETs to reduce the resistance of the power electronics. This ability to manage transient thermal performance can allow the electronic power unit to use passive cooling and a thermoplastic housing without significant risk of melting or damage.

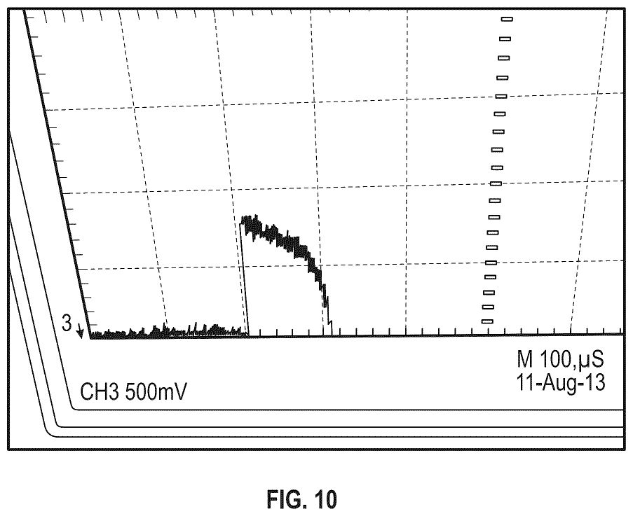

In a particular circuit design like that illustrated in FIG. 9, in a particular system implementation, the circuit takes 30 msec to transition from 5 A to 593 A at a rate of 19,500 A/sec. This initial current rise takes about 13 msec to saturate and create a short circuit (SC) when the shunt power high (SPH) is set to 300 A. FIG. 10 illustrates how the circuit design has a switching time that is less than 1 microsecond (here about 100 milliseconds as illustrated on the oscilloscope readout). Because this time is less than the about 13 microseconds, the switching can be carried out prior to short circuit saturation. Various method implementations can be constructed that utilize this fast switching characteristic of the arrays to help ensure that the transient current does not cause a significant release of thermal energy.

The internal resistance of a battery varies over time and is a key indicator of a battery's lifespan; an increase in resistance often signals that the battery is nearing the end of its useful life. Internal resistance is influenced by factors such as the battery's state of charge and the temperature of its reactive components. As a result, consistently accurately measuring the internal resistance over time to assess battery health can be challenging. This difficulty is compounded when the battery experiences non-uniform loads across different times and temperatures.

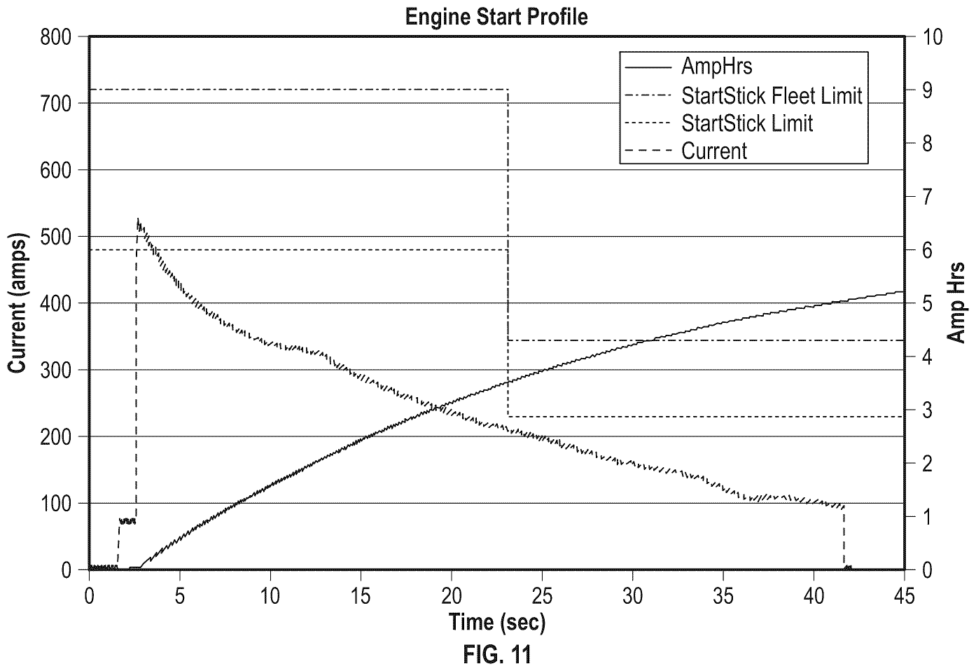

The implementations of electronic power units disclosed in this document are used in conditions that can help assist with generating useful internal resistance data. Part of this is that various engine types that the electronic power units are used to help start show relatively uniform load profiles from engine to engine. For example, the load profile when starting an aircraft turbine engine (see FIG. 11) is quite consistent from turbine engine to turbine engine. This consistency of the load profile serves as an opportunity to use the profile to measure internal resistance of the battery at a point in time as long as the temperature of the measurement is close to a temperature when the internal resistance was initially measured.

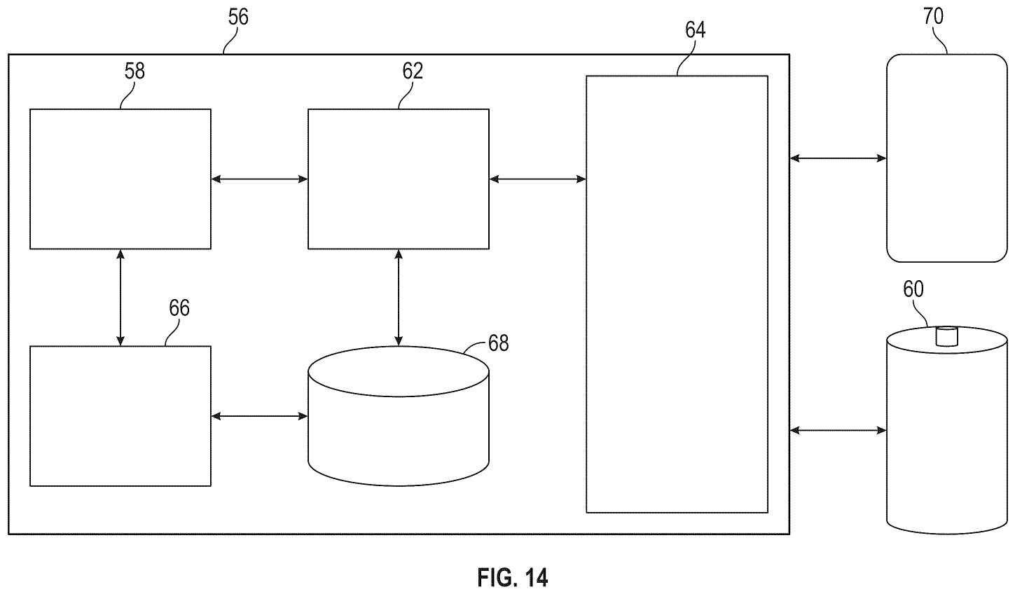

Referring to FIG. 14, an implementation of an electronic power unit battery monitoring system 56 includes an engine start detect module 58 used to detect a sharp rise in current of over 2000 A/sec being released from battery 60 when an engine is being started using the electronic power unit. The system also includes a data collection module 62 used to collect voltage and current data from the battery/battery controller 64 during a predetermined period during the start. The system also includes a data processor module 66 that is used to process the collected data and other current data/historical data as needed to calculate the internal resistance and parametric data of the battery. The system 56 also includes a storage module 68 that assesses the processed data and/or collected data and determines whether the results/data are acceptable and then stores them in a memory for comparison. The various functions of the modules may be implemented using machine readable instructions included in a memory associated with one or more processors configured to execute the machine readable instructions included in the battery controller 64. The processor could be any of a wide variety of processor types including, by non-limiting example, a logic circuit, a microprocessor, a microcontroller, an MCU, a field programmable gate array, or any other processor type.

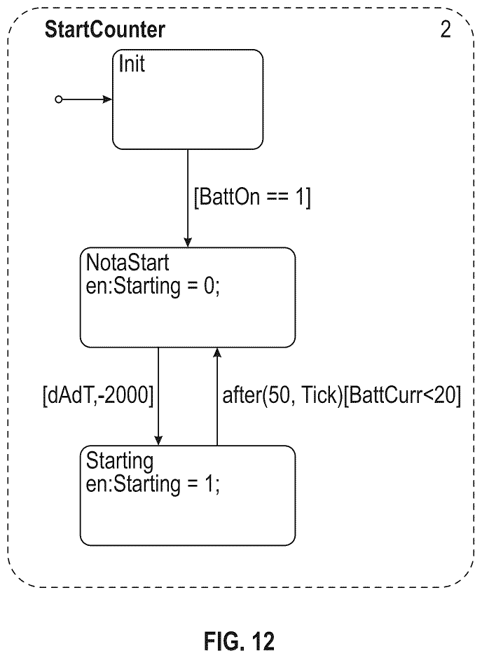

Referring to FIG. 12, a flow diagram of an implementation of a method carried out in an implementation of an engine detect start module is illustrated. Here, a counter is initialized and when a battery on flag indicates the battery is on (1), the variable NotAStart is set to zero and a process begins while the module collects current values at points in time and calculates the rate of change of amperes over time (dA/dT), comparing the calculated rate to the threshold value of 2000 A/sec. After one or more rates of change have been calculated, if the calculated rate of change is 2000 A/sec or greater, then the Starting variable is set to 1, indicating that an engine start has been detected. If after 50 periods of time have passed the measured battery current is less than 20 A, then the NotAStart variable is set to 1 and the module reports that no engine start has been detected. The particular values of current rate and the periods of time used are for the exemplary purposes of this disclosure and the thresholds and other values will vary depending upon what type of engine is being started (turbine engine, diesel engine, etc.).

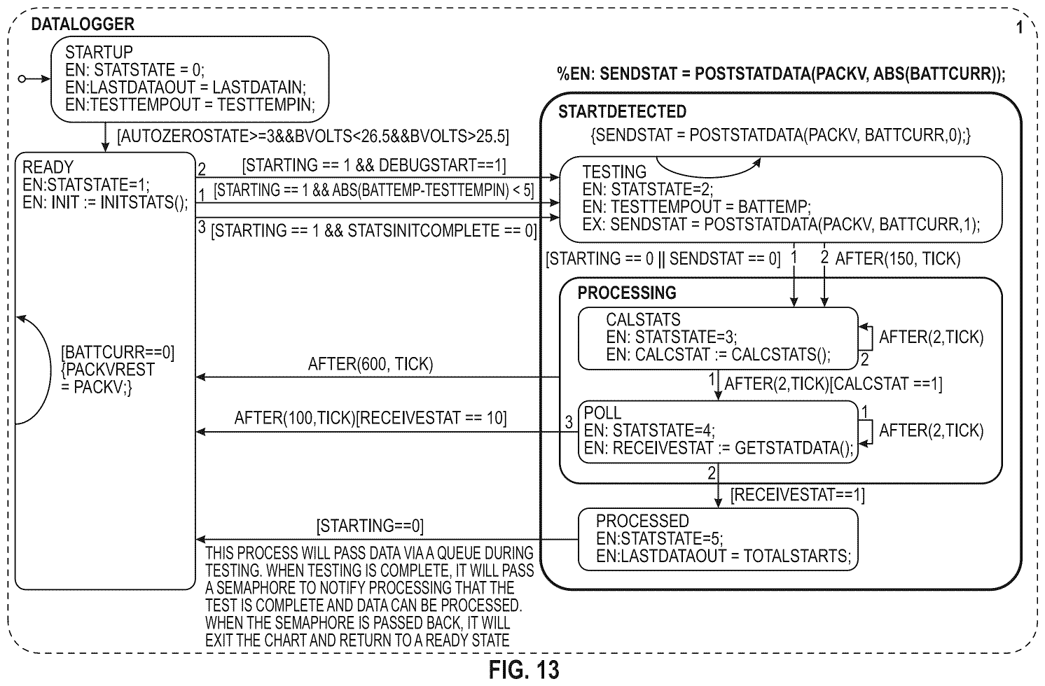

Once the engine detect start module 58 reports that an engine start has been detected, the data collection module 62 begins data collection. FIG. 13 illustrates a flow diagram of a particular implementation of a method of data collection utilized by the data collection module. In a particular implementation, the total number of data points collected may be about 150 data points to allow for capturing most of the current load profile of the engine but also allow for completion of the data collection within a sufficient period of time to allow the other modules to do their work. However, more or less than 150 data points may be collected in various method implementations. Also, various other data collection methods may be utilized to collect data for various engine types.

Following completion of data collection, the data processor module 66 checks the collected data for fidelity and then conducts further processing. In a particular implementation, the fidelity check involves determining whether the collected data is within 5 degrees/percent of a baseline set of data collected when the electronic power unit was new and also to determine whether a minimum number of data samples are included in the collected data. The data processor module 66 then calculates various battery parameters using the collected data. When performing the processing some variables like open circuit voltage of the battery are acquired prior to the engine detect start module beginning its work. Below is an implementation of code that can be executed in machine readable form by the data processor module to calculate the battery resistance (PackResistance) in milliohms.

```
  for (uint32_t i = 0; i < arraySize; i++) { float resistance =
calculateResistance((OpenCircuitVoltage−dataArray[i].PackV),
dataArray[i].BattCurr); resistanceSum += resistance; }
  float calculateResistance(float voltage, float current) { if (current != 0)
return voltage / current * 1000; else return 0; // To avoid division by zero
}
```

The data processor module 66 also calculates a standard deviation of the data to assist with evaluation of the results. A particular implementation of code that can be executed in machine readable form by the data processor module 66 to do this is below:

float standardDeviation = sqrt(sumOfSquaredDifferences / (arraySize −
1)); // Access the data in the array and perform processing

With the processed data, the storage module 68 then conducts various evaluations in various system and method implementations. For example, the calculated standard deviation of the data may not exceed a pre-set level for the data to be deemed acceptable. In a particular implementation, the pre-set level is about 4 milliohms. If the evaluations are acceptable, then the calculated values are compared to corresponding values stored with the battery was new and a percent difference is calculated and stored in the memory by the storage module. In particular implementations, the percent difference is transmitted to the display 70 for display to the user.

The various modules may be implemented in machine readable instructions stored in the memory and executed by the one or more processors where the modules operate using a real time operating system (RTOS). The functions of the modules may be implemented as separate tasks within the RTOS with differing priorities. For example, the data collection module may be executed using a task with a very low priority where the data is received via an RTOS queue and is processed by the data processor module when a semaphore is given to the data processor module.

The challenges with calculating internal resistance and other battery performance measures can use mean internal resistance and standard deviation of internal resistance values to help understand battery health and performance over time. As previously discussed, comparison of these values against those taken when the battery was new can be used to help the electronic power unit flag on its own that a battery problem has been identified. One of the main challenges that the system faces when attempting to calculate meaningful internal resistance data is determining the proper open circuit voltage (OCV) as OCV values need a long rest period that cannot be sensed if the battery is in shutoff mode. The temperature of the battery also needs to be similar from data sample to data sample and close to the temperature of the battery when factory testing was carried out (around 25 C). The difficulties in getting accurate OCV values and variations in temperature due to operational heating and ambient temperature changes can lead to false errors or failures to detect battery problems.

To assist with compensating for these kinds of challenges, the electronic power unit may include a display like any disclosed in this document with a radio communication device within the case that is configured to connect with a cloud computing and storage infrastructure system which the electronic power unit uses to relay raw and/or processed data/measurements to the cloud. For example, the cloud infrastructure can receive battery monitoring system data including battery temperature, battery voltage(s), battery current measurements, calculated data including internal resistance, battery life estimation, state of charge estimation, maximum voltage(s), minimum voltage(s), ambient temperature, internal battery temperature, or any other desired battery sensor variable. The cloud infrastructure can then compare the received data with corresponding data from other electronic power units and use the received data to train an artificial intelligence and/or machine learning model in combination with vehicle type (aircraft type, land vehicle type, engine type, etc.) as parametric data along with other unique identifiers to help with, by non-limiting example, battery maintenance programs, aircraft maintenance programs, engine maintenance programs, engine component failure prediction, aircraft component failure prediction, or many other predictive or diagnostic functions.

In particular implementations, the display may include a computing component that is capable of displaying graphics on the display for use in displaying or recalling data from past use, showing state of health information of the battery, or performing over the air firmware/software updates. The computing component of the display may also be tasked with carrying out the functions of the various battery monitoring system modules previously described in various system implementations.

Referring to FIGS. 7 and 8, the heater 54 includes a plate 72 that has a thickness between largest planar surfaces of the plate 72. The plate 72 includes one or more heating elements either on a surface of the plate or in the plate 72. In some implementations, the one or more heating elements are in a material of the plate 72 (embedded in the plate), like the implementation illustrate in FIG. 8. As previously described, the heater 54 can take the place of the heat sink 48 or can be used in conjunction with the heat sink 48. Where the heat sink 48 is used in conjunction with the heater 54, the heat sink is thermally coupled with the plate 72. In some implementations, the perimeter of the largest planar surface of the heat sink 48 is substantially coextensive with or about the same size as the perimeter of the plate 72 itself. Where the plate 72 and the heat sink 48 are about the same size, their ability to receive and provide heat to the first set of battery cells and second set of battery cells between which they are inserted may be maximized.

The battery controller in various electronic power unit implementations may utilize a microcontroller or other processor like those disclosed herein along with a memory that contains machine readable instructions that when executed by the microcontroller carry out various methods of operation. In a first method of operation, the method includes using a temperature sensor that is operatively coupled with the battery controller (thermistor/thermocouple/etc.) to detect a temperature of a first set of battery cells and a second set of battery cells. If no charger is connected to the electronic power unit, then the method may include generating a prompt on a screen/display of the electronic power unit (like any disclosed herein) asking a user whether to activate the heater. The method may include in response to receiving a signal from the user, sending a signal to the heater controller instructing the heater controller to activate the heater. In various method implementations, the detecting of the charger connection may take automatically within the unit, so the method steps that require user intervention may be omitted in various implementations. When the temperature sensor detects that the temperature of the first set of battery cells and the second set of battery cells has reached a predetermined temperature, the method includes sending a signal to the heater controller to deactivate the heater. The method also includes if the battery controller detects that a future state of charge of the first set of battery cells and the second set of battery cells at the current temperature is below a predetermined level, the battery controller sends a signal to the heater controller instructing the heater to deactivate the heater.

In a second method of operation, the method includes using the temperature sensor coupled to the battery controller to detect a temperature of the first set of battery cells and the second set of battery cells. If a charger is connected to the electronic power unit, the battery controller is used to detect a state of charge (SOC) of the first and second sets of battery cells. If the SOC is below a predetermined level (about 25% in some implementations or the amount of charge needed for one engine start for a particular vehicle in others) and the temperature is below a predetermined temperature the method includes using the battery controller to charge the first and second sets of battery cells until their SOC reaching the predetermined level. The method also includes then reducing the charging rate and sending a signal to the heater controller to activate the heater to heat the first and second sets of battery cells until the temperature reaches the predetermined temperature. If the SOC is below a predetermined level and the temperature of the battery is also below a predetermined level, in another method implementation, the method includes using the battery controller to charge the first and second sets of battery cells until the state of charge reaches the predetermined level. The method also includes sending a signal to the heater controller to activate the heater to heat the first and second sets of battery cells during the charging until the temperature reaches the predetermined temperature.

In a third method implementation, the method includes using the temperature sensor coupled to the battery controller to detect a temperature of the first set of battery cells and the second set of battery cells. The method also includes using the battery controller to detect an SOC of the first and second sets of battery cells. If the starting SOC is at a desired level, the method includes using the battery controller to send a signal to the heater controller to maintain the first set of battery cells and the second set of battery cells at a desired temperature. In some method implementations, if the battery controller has entered or enters a shutdown state during the heating, the method includes using the heater controller to continue to monitor the temperature. If the temperature drops below the desired temperature, the method includes activating the heater to heat the first and second sets of battery cells to a desired temperature.

In a fourth method implementation, the method includes using the heater controller to detect when the electronic power unit is in use and then not beginning heating or ceasing heating. The method may also include tracking the SOC of the first and second sets of battery cells and deactivating the one or more heating elements of the heater when the SOC falls below a predetermined level. The method may also include detecting a fault condition in the first and second set of battery cells and then not beginning heating or ceasing heating. Any combination of the foregoing methods in this paragraph may also be implemented in various method implementations.

In other method implementations, the method includes tracking the future state of charge at the end of heating. This is done using a quadratic equation to predict the net heat (q) gain and then predict the end of charge and estimate the end-state of charge. This is more than just “tracking” as it is a prediction model for SOC.

The various implementations of electronic power units like those disclosed herein may utilize various methods of monitoring a battery of an electronic power unit. Referring to FIG. 14, the method includes using an electronic power unit battery monitoring systems 56 that includes a battery controller 64 that includes a microcontroller or other processor disclosed herein that is operatively coupled to a memory that includes machine readable instructions. The method includes using an engine start module 58 to detect a sharp rise in current supplied from a battery 60 consistent with when an engine is being started with the electronic power unit. The method also includes using a data collection module 62 to collect at least voltage and current data during a predetermined time period after detecting the sharp rise in current. The method also includes storing at least the voltage and current data in the memory using a storage module 68. With a data processor module 66 and the storage module 68, the method includes checking the at least voltage and current data for fidelity using any of the methods disclosed in this document. The method also includes using the data processor module 66 to calculate a present internal resistance of the battery using the at least voltage data and current data. The method also includes using the data processor module 66 to compare the present internal resistance with an original internal resistance. The method also includes displaying the percentage the current internal resistance deviates from the original internal resistance on a display of the electronic power unit using the battery controller.

In various monitoring method implementations, the methods may include using the data processor module 66 calculating an open circuit voltage using the at least voltage and current data. The method may also include where the electronic power unit includes a radio communication device and using the radio communication device, the method includes transmitting over a telecommunication channel the vehicle type associated with the engine being started and the at least voltage and current data to a cloud computing system. The cloud computing system includes a machine learning module trained on historical current and/or voltage data. The method includes using the machine learning model and the vehicle type and the least voltage and current data to predict failure of one or more components of vehicle or to diagnose a problem with the vehicle.

The monitoring method implementation may also include where in response to a selecting by a user of an option on the display, one or more graphics may be displayed that show a state of health of the battery including the present internal resistance of the battery. Various other parameters relating to the battery may be calculated by the data processor module 66 including, by non-limiting example, total engine starts, total battery cycles, maximum observed current, maximum observed battery management system temperature, maximum observed battery temperature, last observed battery temperature, or any combination thereof. The data processor module 66 may also be used to calculate a standard deviation of the at least voltage and current data. This standard deviation may be used in assessing the fidelity of the data and/or in assessing the current state of the battery.

In places where the description above refers to particular implementations of electronic power units and implementing components, sub-components, methods and sub-methods, it should be readily apparent that a number of modifications may be made without departing from the spirit thereof and that these implementations, implementing components, sub-components, methods and sub-methods may be applied to other electronic power units.

1. A heating system for an electronic power unit comprising:
a plate comprising one or more heating elements, the plate comprising a thickness;
a metal oxide field effect transistor electrically coupled with the one or more heating elements of the plate; and
a heater controller electrically coupled with the metal oxide field effect transistor and with the one or more heating elements;
wherein a thickness of the plate is dimensioned to allow the plate to be inserted between a first set of battery cells and a second set of battery cells of an electronic power unit; and
wherein a perimeter of the plate is dimensioned to fit entirely within an enclosure of an electronic power unit.

2. The heating system of claim 1, wherein the one or more heating elements are on a surface of the plate.

3. The heating system of claim 1, wherein the one or more heating elements are in the plate.

4. The heating system of claim 1, wherein the one or more heating elements are in a material of the plate.

5. The heating system of claim 1, further comprising a heat sink thermally coupled with the plate.

6. The heating system of claim 5, wherein a perimeter of a largest planar surface of the heat sink is substantially coextensive with the perimeter of the plate.

7. The heating system of claim 1, further comprising a battery controller comprising a microcontroller and memory comprising machine readable instructions that, when executed by the microcontroller are configured to:
use a temperature sensor operatively coupled to the battery controller, detect a temperature of first set of battery cells and the second set of battery cells;
if no charger is connected to the electronic power unit:
send a signal to the heater controller instructing the heater controller to activate the heater; and
when the temperature sensor detects that the temperature of the first set of battery cells and second set of battery cells has reached a predetermined temperature, send a signal to the heater controller to deactivate the heater; and
if the battery controller detects that a future state of charge of the first set of battery cells and second set of battery cells at the current temperature is below a predetermined level, the battery controller sends a signal to the heater controller instructing the heater to deactivate.

8. The heating system of claim 1, further comprising a battery controller comprising a microcontroller and memory comprising machine readable instructions that, when executed by the microcontroller are configured to:
use a temperature sensor operatively coupled to the battery controller, detect a temperature of first set of battery cells and the second set of battery cells;
if a charger is connected to the electronic power unit:
using the battery controller, detect a state of charge of the first set of battery cells and second set of battery cells and one of:
if the state of charge is below a predetermined level and the temperature is below a predetermined temperature:
with the battery controller, charge the first set of battery cells and second set of battery cells until the state of charge reaches the predetermined level;
reduce the charging rate; and
send a signal to the heater controller to activate the heater to heat the first set of battery cells and second set of battery cells until the temperature reaches the predetermined temperature; or
if the state of charge is below a predetermined level and the temperature of the battery is below a predetermined temperature:
with the battery controller, charge the first set of battery cells and second set of battery cells until the state of charge reaches the predetermined level; and
send a signal to the heater controller to activate the heater to heat the first set of battery cells and second set of battery cells during the charging until the temperature reaches the predetermined temperature.

9. The heating system of claim 1, further comprising a battery controller comprising a microcontroller and memory comprising machine readable instructions that, when executed by the microcontroller are configured to:
use a temperature sensor operatively coupled to the battery controller, detect a temperature of the first set of battery cells and the second set of battery cells;
using the battery controller, detect a state of charge of the first set of battery cells and second set of battery cells;
if the starting state of charge is at a desired level, with the battery controller, send a signal to the heater controller to maintain the first set of battery cells and second set of battery cells at a desired temperature;
if the battery controller enters a shutdown state, use the heater controller to continue to monitor the temperature and if the temperature drops below the desired temperature, activating the heater to heat the first set of battery cells and the second set of battery cells to a desired temperature.

10. The heating system of claim 1, wherein the heater controller is configured to:
detect when the electronic power unit is in use and one of not beginning heating or ceasing heating;
track a state of charge of the first set of battery cells and second set of battery cells and deactivating the one or more heating elements when the state of charge falls below a predetermined level;
detect a fault condition in the first set of battery cells and second set of battery cells and not beginning heating or ceasing heating; or
any combination thereof.

11. A method of recharging an electronic power unit, the method comprising:
using an electronic power unit, starting an engine of a vehicle;
maintaining the electronic power unit in electrical connection with the vehicle after starting the engine; and
receiving electrical charge from the vehicle into the electronic power unit to charge the electronic power unit.

12. The method of claim 11, wherein the electrical charge fully recharges the electronic power unit.

13. The method of claim 11, wherein the electrical charge partially recharges the electronic power unit.

14. The method of claim 11, wherein the electrical charge replaces electrical charge discharged from the electronic power unit while starting the engine of the vehicle.

15. The method of claim 11, wherein receiving electrical charge from the vehicle into the electronic power unit further comprises receiving at an end of the electronic power unit used to start the engine of the vehicle.

16. An electronic power unit comprising:
a heater disposed in a battery pack, the heater electrically coupled with a heater controller and with a battery controller; and
an exterior case, the exterior case enclosing the heater and the battery pack, the exterior case comprising an end that accommodates the power input of a military vehicle, the end comprising a coaxial connector.

17. The electronic power unit of claim 16, wherein the coaxial connector is a North American Treaty Organization connector.

18. The electronic power unit of claim 16, wherein an outer surface of the end is substantially cylindrical and wherein the end comprises a single substantially cylindrical opening therein.

19. The electronic power unit of claim 17 wherein the coaxial connector contains a non-metallic, electrically conductive, field serviceable tip that prevents transfer of metal or welding of the coaxial connector when it is attached directly to an active load that would cause material transfer or arching upon contact.

20. The method of claim 11, where the field-serviceable tip is coupled using a screw.
